(19) United States
(12) Patent Application Publication
(10) Pub. No.: US 2014/0315119 A1
(43) Pub. Date: Oct. 23, 2014

(54) HIGHLY CONDUCTIVE ANION-EXCHANGE COMPOSITE MEMBRANE WITH CROSSLINKED POLYMER ELECTROLYTE FOR ALKALINE FUEL CELL AND METHOD FOR PREPARING THE SAME

(71) Applicant: Korea Institute Of Energy Research, Daejeon (KR)

(72) Inventors: Young Woo Choi, Chungcheongbuk-do (KR); Hyun Gu Kang, Gyeonggi-do (KR); Mi Soon Lee, Daejeon (KR); Tae Hyun Yang, Daejeon (KR); Chang Soo Kim, Incheon (KR); Young Gi Yoon, Daejeon (KR); Seok Hee Park, Daejeon (KR); Sung Dae Yim, Daejeon (KR); Gu Gon Park, Daejeon (KR); Young Jun Sohn, Daejeon (KR); Minjin Kim, Daejeon (KR); Byungchan Bae, Seoul (KR)

(21) Appl. No.: 13/925,073

(22) Filed: Jun. 24, 2013

(30) Foreign Application Priority Data
Apr. 23, 2013 (KR) 10-2013-0044857

(51) Int. Cl. H01M 8/10

(52) U.S. Cl. CPC H01M 8/1069; H01M 2008/1095
USPC 429/492; 427/508

(57) ABSTRACT

Disclosed are a new method for preparing a highly conductive anion-exchange composite membrane with a crosslinked polymer electrolyte for an alkaline fuel cell and a composite membrane prepared by the same. The method includes (A) mixing (vinylbenzyl)trimethylammonium chloride, 1,3,5-triacryloylhexahydro-1,3,5-triazine, and a mixed solution of deionized water and dimethyl formamide at a weight ratio of 1:1 together by stirring at a weight ratio of 60˜75:5˜16:20˜25; (B) mixing 100 parts by weight of the mixed solution with 0.5 to 2 parts by weight of a photoinitiator; (C) impregnating a porous polymer support with the solution so that a monomer solution soaks into the support; (D) interposing an electrolyte-impregnated membrane between polyethylene terephthalate (PET) films and irradiating the electrolyte-impregnated membrane with ultraviolet (UV) light having an energy of 30 to 150 mJ/cm² for crosslinking; and (E) after the crosslinking step, removing the PET films, and removing by-products on the membrane surface and washing the membrane.

### BACKGROUND OF THE INVENTION

1.Field of the Invention

The present invention relates to a highly conductive anion-exchange composite membrane with a crosslinked polymer electrolyte for an alkaline fuel cell and a method for preparing the same, and more particularly, to a technology for the preparation of a highly conductive anion-exchange composite membrane with a crosslinked polymer electrolyte for an alkaline fuel cell which has high ion-exchange capacity and high hydroxide ion conductivity even with the use of a low content of crosslinking agent.

2. Discussion of the Related Art

A fuel cell is a device that generates electrical energy from fuel and air supplied from the outside by using electrodes. The fuel cell has the advantage of improving the efficiency of fuel use and generating less environmental pollutants such as emissions. Moreover, while the existing primary and secondary cells are devices that charge and discharge a limited amount of energy, fuel cells produce electrical energy continually for as long as fuel is supplied. Hence, there is much research conducted on the fuel cells, which are emerging as the next generation clean energy source.

An ion-exchange membrane is a kind of polymer separation membrane, which is capable of selectively separating anions and cations depending on the type of ion exchange group introduced into the membrane. For a cation exchange membrane, which is available for commercial use, the ion exchange groups are roughly classified into strongly acidic sulfonic acid groups (—SO₃—) and weakly acidic carboxylic acid groups (—COO—). For an anion exchange membrane, a strong basic quaternary ammonium group (—N+R3) is usually used as the ion exchanger.

Such ion exchange membranes are used in electrolysis for desalination and purification, water-splitting electrolysis, diffusion dialysis for recovery of acid from an acid waste solution, electrodeionization for ultrapure water production, and so on. Moreover, following the recent report about the possibility of using an anion-exchange membrane for fuel cells, more and more research is being conducted to use an anion-exchange membrane for fuel cells.

A fuel cell includes a fuel electrode (anode) for supplying hydrogen ions and electrons from hydrogen or methanol and an air electrode (cathode) for supplying oxygen. A fuel cell produces electricity on the principle that when fuel is supplied from the fuel electrode, the fuel is divided into hydrogen ions and electrons, the hydrogen ions are combined with oxygen supplied from the air electrode through an electrolyte membrane to form water, and the electrons separated from the fuel in the fuel electrode produce current through an external circuit, thereby generating electricity, heat, and water by an electrochemical reaction, which is the reverse of electrolysis of water. Different types of fuel cells include polymer electrolyte membrane fuel cells (PEMFC), direct methanol fuel cells (DMFC), direct borohydride fuel cells (DBFC), and solid alkaline fuel cells (SAFC). Among these types of fuel cells, the polymer electrolyte membrane fuel cells, the direct methanol fuel cells, and the direct borohydride fuel cells have to employ a cation-exchange membrane, a cation or hydrogen-ion conducting electrolyte membrane, as the electrolyte. On the other hand, the solid alkaline fuel cells and the direct borohydride fuel cells have to employ an anion-exchange membrane, a hydroxyl-ion conducting electrolyte membrane, as the electrolyte. The direct borohydride fuel cells can use both the cation-exchange membrane and the anion-exchange membrane.

Unlike fuel cells employing a cation-exchange membrane, fuel cells employing an anion-exchange membrane can use non-precious metal catalysts or non-platinum catalysts for electrodes, thus achieving cost reduction. Accordingly, research on the preparation of anion-exchange membranes is increasingly conducted for the development of fuel cells employing an anion-exchange membrane.

The present inventor filed a patent application (KR10-2009-0053006), in which ionized water, [(3-acrylamidoprpyl)trimethylammonium chloride], and N,N′-ethylenbisacrylamide are mixed together by stirring, 100 parts by weight of the mixed solution is mixed with 1 part by weight of a dilution of Darocur 1173 (10 wt %) as a photoinitiator in methanol, a porous polyethylene support is impregnated with the solution so that a monomer solution sufficiently soaks into the support, the solution-impregnated porous support is interposed between polyethylene terephthalate (PET) films and irradiated with ultraviolet (UV) light having an energy of 30 to 150 mJ/cm² to prepare an anion-exchange composite membrane with a crosslinked polymer electrolyte. Also, the present inventor filed a patent application No. KR10-2012-0043042, which concerns a method of preparing a composite polymer membrane by adding 0.5 to 2 parts by weight of photoinitiator to 100 parts by weight of a mixed solution of 48 to 86 parts by weight of vinylbenzyl trimethylammonium as an electrolytic monomer of quaternary ammonium salts, 2 to 4 parts by weight of N,N′-bisacryloylpiperazine as a bisacrylamide crosslinking agent having a tertiary amino group, and 10 to 50 parts by weight of water.

The present inventor perfected the present invention through further research upon finding that an anion conducting composite membrane with a crosslinked polymer electrolyte which has high ion-exchange capacity and high hydroxide ion conductivity even with the use of a low content of crosslinking agent.

### SUMMARY OF THE INVENTION

A technical task of the present invention is to provide a method for preparing a highly conductive anion-exchange composite membrane with a crosslinked polymer electrolyte for a fuel cell, which has high ion-exchange capacity and high hydroxide ion conductivity by a simple production process.

Another task of the present invention is to provide a highly conductive anion-exchange composite membrane with a crosslinked polymer electrolyte for a fuel cell, which has high ion-exchange capacity and high hydroxide ion conductivity.

To accomplish the above-described tasks, the present invention provides a method for preparing a highly conductive anion-exchange composite membrane with a crosslinked polymer electrolyte, the method including: (A) mixing (vinylbenzyl)trimethylammonium chloride, 1,3,5-triacryloylhexahydro-1,3,5-triazine, and a mixed solution of deionized water and dimethyl formamide at a weight ratio of 1:1 together by stirring at a weight ratio of 60˜75:5˜16:20˜25; (B) mixing 100 parts by weight of the mixed solution with 0.5 to 2 parts by weight of a photoinitiator; (C) impregnating a porous polymer support with the solution so that a monomer solution soaks into the support; (D) interposing an electrolyte-impregnated membrane between polyethylene terephthalate (PET) films and irradiating the electrolyte-impregnated membrane with ultraviolet (UV) light having an energy of 30 to 150 mJ/cm² for crosslinking; and (E) after the crosslinking step, removing the PET films, and removing by-products on the membrane surface and washing the membrane.

The photoinitiator may be a dilution of 2-hydroxy-2-methyl-1-phenyl-1-one (10 wt %) in methanol. Moreover, the method may further include, after the washing step, putting the membrane into a sodium hydroxide solution and substituting OH— ions for Cl— ions.

The porous support is preferably a porous hydrocarbon film having a void volume of 30 to 60%, a pore size of 0.05 to 0.1 micrometers, and a thickness of 20 to 55 micrometers, more preferably, a polyolefin film.

To accomplish the above-described tasks, the present invention provides a highly conductive anion-exchange composite membrane with a crosslinked polymer electrolyte, which is prepared by the above-described preparation method and has high ion-exchange capacity and high hydroxide ion conductivity.

According to the present invention, it is possible to prepare a highly conductive anion exchange composite membrane with a crosslinked polymer electrolyte which has high ion-exchange capacity and high hydroxide ion conductivity even with the use of a low content of initiator. The anion-conducting composite membrane with a crosslinked polymer electrolyte prepared by the above preparation method may be widely used in the industry of fuel cells including solid alkaline fuel cells owing to their excellent hydroxide ion conductivity at ambient temperature.

### DETAILED DESCRIPTION OF THE PREFERRED EMBODIMENTS

Hereinafter, the present invention will be described below in detail.

According to a concrete embodiment of the present invention, there is provided a method for preparing a highly conductive anion-exchange composite membrane with a crosslinked polymer electrolyte, the method including: (A) mixing (vinylbenzyl)trimethylammonium chloride, 1,3,5-triacryloylhexahydro-1,3,5-triazine, and a mixed solution of deionized water and dimethyl formamide at a weight ratio of 1:1 together by stirring at a weight ratio of 60˜75:5˜16:20˜25; (B) mixing 100 parts by weight of the mixed solution with 0.5 to 2 parts by weight of a photoinitiator; (C) impregnating a porous polymer support with the solution so that a monomer solution soaks into the support; (D) interposing an electrolyte-impregnated membrane between polyethylene terephthalate (PET) films and irradiating the electrolyte-impregnated membrane with ultraviolet (UV) light having an energy of 30 to 150 mJ/cm² for crosslinking; and (E) after the crosslinking step, removing the PET films, and removing by-products on the membrane surface and washing the membrane.

The photoinitiator may be a dilution of 2-hydroxy-2-methyl-1-phenyl-1-one (10 wt %) in methanol. Moreover, the method may further include, after the washing step, putting the membrane into a sodium hydroxide solution and substituting OH— ions for Cl— ions. Through this step, sufficient hydroxide ion conductivity can be obtained. The porous support is preferably a porous hydrocarbon film having a void volume of 30 to 60%, a pore size of 0.05 to 0.1 micrometers, and a thickness of 20 to 55 micrometers, more preferably, a polyolefin film.

In the step (A), vinylbenzyl trimethylammonium chloride as represented by the following Chemical Formula I is used as an electrolytic monomer.

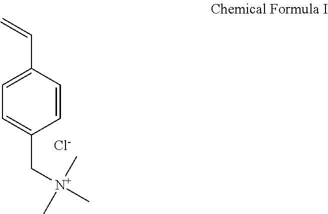

In the present invention, 1,3,5-triacryloylhexahydro-1,3,5-triazine as represented by the following Chemical Formula II, which is a compound having three crosslinking sites, is used as the initiator.

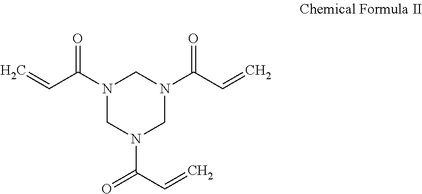 [SMILES: C=CC(=O)N1CN(C(=O)C=C)CN(C(=O)C=C)C1]

A mixed solution of deionized water and dimethyl formamide at a weight ratio of 1:1 is preferably used as a solvent.

(vinylbenzyl)trimethylammonium chloride used as the monomer, 1,3,5-triacryloylhexahydro-1,3,5-triazine used as a crosslinking agent, and the mixed solution of deionized water and dimethyl formamide at a weight ratio of 1:1 are mixed together by stirring at a weight ratio of 60˜75:5˜16:20˜25.

Preferably, 0.5 to 2 parts by weight of the initiator are added to 100 parts by weight of the mixed solution.

A photoinitiator for radical polymerization is preferably used as the initiator. The initiator is preferably, but not specifically limited to, 2-hydroxy-2-methyl-1-phenyl-1-one.

In the step (C), the porous polymer support is preferably a porous hydrocarbon film having a void volume of 30 to 60%, a pore size of 0.05 to 0.1 micrometers, and a thickness of 20 to 55 micrometers, more preferably, a polyolefin film. If the properties of the porous polymer support are not in these ranges, this impairs proper membrane formation, and as a result, leads to performance degradation when applied to fuel cells.

In the step (D), it is preferable that the porous polymer support is vertically stacked between polyethylene terephthalate (PET) films. Also, in this step, it is preferable that a photocrosslinking reaction is performed by irradiation with ultraviolet light. Preferably, the ultraviolet light has energy of 30 to 150 mJ/cm².

The monomer and the crosslinking agent complete their reaction within the porous support, thus forming the structure as shown in the following Chemical Formula.

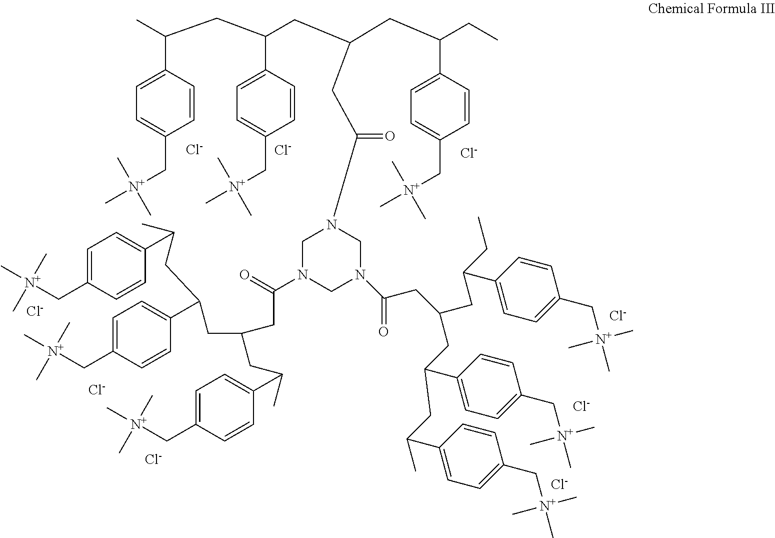

After the crosslinking step, the PET films are removed, by-products on the composite membrane surface are removed to make the surface even, and then the composite membrane is washed several times with ultrapure water, thereby preparing a polymer composite membrane. Subsequently, the membrane may be put into a sodium hydroxide solution, and OH— ions may be substituted for Cl— ions to maximize hydroxide ion conductivity.

The thus-prepared polymer composite membrane may have the same crosslink density as the prior art polymer composite membranes (KR10-2009-0053006 and KR10-2012-0043042), even with the use of a low content of crosslinking agent.

Since 1,3,5-triacryloylhexahydro-1,3,5-triazine used as the crosslinking agent has three crosslinking sites, the same crosslink density can be obtained with the use of only two-thirds of the conventional crosslinking agent having two crosslinking sites. Accordingly, the content of the electrolytic monomer used increases, and hence the hydroxide-ion exchange capacity may substantially increase relative to the same membrane weight and the hydroxide ion conductivity is much improved.

### EXAMPLES

Hereinafter, the present invention will be described in more detail by examples.

However, the following Examples are only illustrative of the present invention and the present invention is not limited by the following Examples.

### Example 1

### Preparation of Highly Conductive Anion-Exchange Composite Membrane with Crosslinked Polymer Electrolyte

(vinylbenzyl)trimethylammonium chloride, 1,3,5-triacryloylhexahydro-1,3,5-triazine, and a mixed solution of deionized water and dimethyl formamide at a weight ratio of 1:1 were mixed together by stirring at a weight ratio of 61.5:15.4:23.1, and 100 parts by weight of the mixed solution was mixed with 1 part by weight of a dilution of 2-hydroxy-2-methyl-1-phenyl-1-one (10 wt %) as a photoinitiator in methanol.

Afterwards, a polyolefin-based porous polymer support having a film thickness of 25 μm, an average pore size of 0.07 μm, and a pore distribution of 45% was impregnated with the solution so that a monomer solution soaks into the support. Subsequently, an electrolyte-impregnated membrane was interposed between polyethylene terephthalate (PET) films and then irradiated with ultraviolet (UV) light having an energy of 30 to 150 mJ/cm².

After the crosslinking step, the PET films were removed, by-products on the membrane surface were removed to make the surface even, and then the composite membrane was washed several times with ultrapure water, thereby preparing a polymer composite membrane. Subsequently, the membrane was put into a 2N sodium hydroxide solution, and OH— ions were substituted for Cl— ions to attain sufficient hydroxide ion conductivity. Hence, a final polymer composite membrane of this invention was prepared.

### Example 2

### Preparation of Highly Conductive Anion-Exchange Composite Membrane with Crosslinked Polymer Electrolyte

A highly conductive anion-exchange composite membrane with a crosslinked polymer electrolyte was prepared by the same procedure as described in Example 1, except that (vinylbenzyl)trimethylammonium chloride, 1,3,5-triacryloylhexahydro-1,3,5-triazine, and a mixed solution of deionized water and dimethyl formamide at a weight ratio of 1:1 were mixed together at a weight ratio of 70.6:5.9:23.5.

### Comparative Example 1

### Preparation of Anion-Exchange Composite Membrane with Crosslinked Polymer Electrolyte

(vinylbenzyl)trimethylammonium chloride, N,N′-bisacryloylpiperazine, and deionized water were mixed together by stirring at a weight ratio of 61.5:15.4:23.1, and 100 parts by weight of the mixed solution was mixed with 1 part by weight of a dilution of Darocur 1173 (10 wt %) as a photoinitiator in methanol. Afterewards, a porous polyethylene-based support having a film thickness of 25 μm, an average pore size of 0.07 μm, and a pore distribution of 45% was impregnated with the solution so that a monomer solution soaks into the support. Subsequently, an electrolyte-impregnated membrane was interposed between polyethylene terephthalate (PET) films and the electrolyte-impregnated membrane was irradiated with ultraviolet (UV) light having an energy of 30 to 150 mJ/cm².

After the crosslinking step, the PET films were removed, by-products on the membrane surface were removed to make the surface even, and then the composite membrane was washed several times with ultrapure water, thereby preparing a polymer composite membrane. Subsequently, the membrane was put into a 2N sodium hydroxide solution, and OH— ions were substituted for Cl— ions, thereby preparing a polymer composite membrane.

### Comparative Example 2

### Preparation of Anion-Exchange Composite Membrane with Crosslinked Polymer Electrolyte

An anion-Exchange composite membrane with a crosslinked polymer electrolyte was prepared by the same procedure as described in Example 1, except that (vinylbenzyl)trimethylammonium chloride, N,N′-bisacryloylpiperazine, and deionized water were mixed together at a weight ratio of 70.6:5.9:23.5.

### Test Example 1

### Tensile Strength Test

The tensile strength (kpsi) of the electrolyte membranes prepared in the above Examples and Comparative Examples were measured by the method prescribed in ASTM 882.

### Test Example 2

### Measurement of Hydroxide Ion Conductivity

The electrolyte membranes prepared in the above Examples and Comparative Examples were immersed in distilled water of 25° C. for 1 hour, and inserted between two glass substrates fixed with a rectangular platinum electrode without removing the water on the membrane surface, and then the glass substrates were fixed. Afterwards, the alternating-current impedance at 100 Hz to 4 MHz was measured to make a measurement of hydroxide ion conductivity.

### Test Example 3

### Measurement of Ion-Exchange Capacity

The polymer composite membranes prepared in the above Examples and Comparative Examples were immersed for 24 hours in a 2N sodium hydroxide aqueous solution, OH— ions were substituted for Cl— ions, and then the membranes were washed several times with ultrapure water to attain sufficient hydroxide ion conductivity. Afterwards, the membranes were immersed again for 24 hours in a 3M sodium chloride aqueous solution to displace the OH— ions from the membrane. Next, 0.01 N hydrogen chloride was added dropwise to the resulting sodium chloride aqueous solution containing the hydroxide ions by using a potentiometric titrator.

The results of the test examples were shown in Table 1.

TABLE 1

| | | Comparative | | Comparative |
|---|---|---|---|---|
| | Example 1 | Example 1 | Example 2 | Example 2 |
| tensile strength | 23/20 | 23/20 | 23/20 | 23/20 |
| (MD/TD, kpsi) | | | | |
| hydroxide ion | 0.061 | 0.033 | 0.045 | 0.025 |
| conductivity (S/cm) | | | | |
| ion-exchange | 2.31 | 1.60 | 1.92 | 1.35 |
| capacity (meq/g) | | | | |

MD: machine direction
TD: transverse direction

As seen from Table 1, the electrolyte composite membranes prepared in Examples 1 and 2 of this invention show excellent hydroxide ion conductivity and ion-exchange capacity, compared to the electrolyte composite membranes of Comparative Examples 1 and 2.

Moreover, it can be found out that the electrolyte composite membranes of this invention can be mass-produced by a continuous production process because they are excellent and stable in tensile strength. Therefore, they may be widely used as membranes for low-price, environmentally-friendly hydrocarbon fuel cells if a mass-production system is built.

What is claimed is:

1. A method for preparing a highly conductive anion-exchange composite membrane with a crosslinked polymer electrolyte, the method comprising:
(A) mixing (vinylbenzyl)trimethylammonium chloride, 1,3,5-triacryloylhexahydro-1,3,5-triazine, and a mixed solution of deionized water and dimethyl formamide at a weight ratio of 1:1 together by stirring at a weight ratio of 60˜75:5˜16:20˜25;
(B) mixing 100 parts by weight of the mixed solution with 0.5 to 2 parts by weight of a photoinitiator;
(C) impregnating a porous polymer support with the solution so that a monomer solution soaks into the support;
(D) interposing an electrolyte-impregnated membrane between polyethylene terephthalate (PET) films and irradiating the electrolyte-impregnated membrane with ultraviolet (UV) light having an energy of 30 to 150 mJ/cm² for crosslinking; and
(E) after the crosslinking step, removing the PET films, and removing by-products on the membrane surface and washing the membrane.

2. The method of claim 1, wherein the photoinitiator is a dilution of 2-hydroxy-2-methyl-1-phenyl-1-one (10 wt %) in methanol.

3. The method of claim 1, further comprising, after the washing step, putting the membrane into a sodium hydroxide solution and substituting OH— ions for Cl— ions.

4. The method of claim 1, wherein the porous support is a porous hydrocarbon film having a void volume of 30 to 60%, a pore size of 0.05 to 0.1 micrometers, and a thickness of 20 to 55 micrometers.

5. A highly conductive anion-exchange composite membrane with a crosslinked polymer electrolyte for an alkaline fuel cell prepared according to the method of claim 1.

6. A fuel cell comprising the highly conductive anion-exchange composite membrane with a crosslinked polymer electrolyte for an alkaline fuel cell of claim 5.
